(19) United States
(12) Patent Application Publication
(10) Pub. No.: US 2019/0309641 A1
(43) Pub. Date: Oct. 10, 2019

(54) GAS TURBINE ENGINE HAVING CANTILEVERED STATORS WITH SEALING MEMBERS

(71) Applicant: UNITED TECHNOLOGIES CORPORATION, Farmington, CT (US)

(72) Inventors: William R. Edwards, Stratham, NH (US); Philip Robert Rioux, Lisbon Falls, ME (US); Mark David Ring, Cape Neddick, ME (US)

(21) Appl. No.: 15/945,409

(22) Filed: Apr. 4, 2018

(51) Int. Cl. F01D 11/00; F01D 9/04; F04D 29/44

(52) U.S. Cl. CPC F01D 11/005; F01D 9/041; F05D 2260/30; F05D 2220/32; F04D 29/444

(57) ABSTRACT

A cantilevered mounted singlet vane includes a first outer shroud and a first airfoil. The first outer shroud is provided with a first body having a first body first side and a first body second side axially extending between a first body first end and a first body second end. The first outer shroud defines a first slot axially extends from the first body first end towards a first body end wall disposed at the second end. The first airfoil radially extends from the first outer shroud.

### BACKGROUND

Exemplary embodiments of the present disclosure pertain to the art of gas turbine cantilevered stator vanes.

A gas turbine engine may include a fan section, a compressor section, a combustor section, and a turbine section. The compressor section and the turbine section typically may include stator assemblies that are interspersed between rotating airfoils. The stator assemblies may include a plurality of vanes supported between upper and lower platforms. Air flow may leak through gaps between either the upper or lower platforms that may reduce overall gas turbine engine efficiency.

### BRIEF DESCRIPTION

Disclosed is a stator vane assembly that includes a first stator vane. The first stator vane includes a first outer shroud and a first airfoil. The first outer shroud is mounted to a vane shroud such that the first stator vane is a cantilevered mounted singlet vane. The first outer shroud is provided with a first body having a first body first side and a first body second side axially extending between a first body first end and a first body second end. The first outer shroud defines a first slot axially extends from the first body first end towards a first body end wall disposed at the second end. The first airfoil radially extends from the first outer shroud.

In addition to one or more of the features described above, or as an alternative to any of the foregoing embodiments, the first body first end defines a first opening axially extends into the first slot.

In addition to one or more of the features described above, or as an alternative to any of the foregoing embodiments, the first slot circumferentially extends from the first body first side towards a first side wall that is disposed between the first body first side and the first body second side.

In addition to one or more of the features described above, or as an alternative to any of the foregoing embodiments, a sealing member disposed at least partially in the first slot.

In addition to one or more of the features described above, or as an alternative to any of the foregoing embodiments, the sealing member is provided with a beveled region that is disposed proximate the first body end wall.

Also disclosed is a stator vane assembly that includes a first stator vane and a second stator vane. The first stator vane includes a first outer shroud mounted to a vane shroud. The first outer shroud is provided with a first body having a first body first side and a first body second side axially extending between a first body first end and a first body second end. The first body defines a first recess that circumferentially extends from the first body first side, along a first floor, towards a first side wall and axially extends from the first end, along the first floor, towards a first body end wall disposed proximate the first body second end. The second stator vane includes a second outer shroud mounted to the vane shroud. The second outer shroud is provided with a second body having a second side wall axially extending between a second body first end and a second body second end, the second body having a tongue that circumferentially extends from the second side wall, the tongue arranged to be at least partially received within the first recess.

In addition to one or more of the features described above, or as an alternative to any of the foregoing embodiments, a first lip axially extends from the first body first end.

In addition to one or more of the features described above, or as an alternative to any of the foregoing embodiments, a second lip axially extends from the second body first end and is arranged to abut the first lip.

In addition to one or more of the features described above, or as an alternative to any of the foregoing embodiments, the tongue axially extends between a first tongue end that is disposed parallel to and generally coplanar with the second body first end and a second tongue end that is arranged to abut the first body end wall.

In addition to one or more of the features described above, or as an alternative to any of the foregoing embodiments, the second tongue end is disposed parallel to and is axially offset from the second body second end.

In addition to one or more of the features described above, or as an alternative to any of the foregoing embodiments, the tongue circumferentially extends between the second side wall and a tongue end wall that is arranged to be disposed proximate the first side wall.

In addition to one or more of the features described above, or as an alternative to any of the foregoing embodiments, the first side wall is disposed in a nonparallel and non-perpendicular relationship with the tongue end wall.

Further disclosed is a gas turbine engine that includes a first stator vane. The first stator vane includes a first outer shroud mounted to a vane shroud such that the first stator vane is a cantilevered mounted singlet vane. The first stator vane having a first body provided with a first wall spaced apart from a second wall axially extends between a first body first end and a first body second end. The first wall axially extends between a first body first side and a first body second side. A first body end wall radially extends between the first wall and the second wall and is disposed proximate the first body second end. A first side wall radially extends between the first wall and the second wall and axially extends between the first body end wall and the first body first end, the first wall, the second wall, the first body end wall, and the first side wall defining a first slot.

In addition to one or more of the features described above, or as an alternative to any of the foregoing embodiments, the second wall is radially spaced apart from the first wall.

In addition to one or more of the features described above, or as an alternative to any of the foregoing embodiments, a sealing member at least partially received within the first slot.

In addition to one or more of the features described above, or as an alternative to any of the foregoing embodiments, the first outer shroud has a first hook that extends from the first body first end and a second hook that extends from the first body second end.

In addition to one or more of the features described above, or as an alternative to any of the foregoing embodiments, the first body defines a first opening axially extends from the first body first end into the first slot.

In addition to one or more of the features described above, or as an alternative to any of the foregoing embodiments, a liner disposed about the first hook and having a portion that extends over the first opening.

In addition to one or more of the features described above, or as an alternative to any of the foregoing embodiments, the portion of the liner is disposed parallel to the first body end wall.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a partial perspective view of a stator vane assembly;

FIG. 3A is a perspective view of a stator vane of the stator vane assembly of the gas turbine engine;

FIG. 3B is a perspective view of a stator vane of the stator vane assembly of the gas turbine engine;

FIG. 4 is a partial perspective view of a first stator vane of the stator vane assembly;

FIG. 5 is a partial perspective view of a second stator vane of the stator vane assembly; and

FIG. 6 is a plan view of the first stator vane and the second stator vane joined together.

### DETAILED DESCRIPTION

A detailed description of one or more embodiments of the disclosed apparatus and method are presented herein by way of exemplification and not limitation with reference to the Figures.

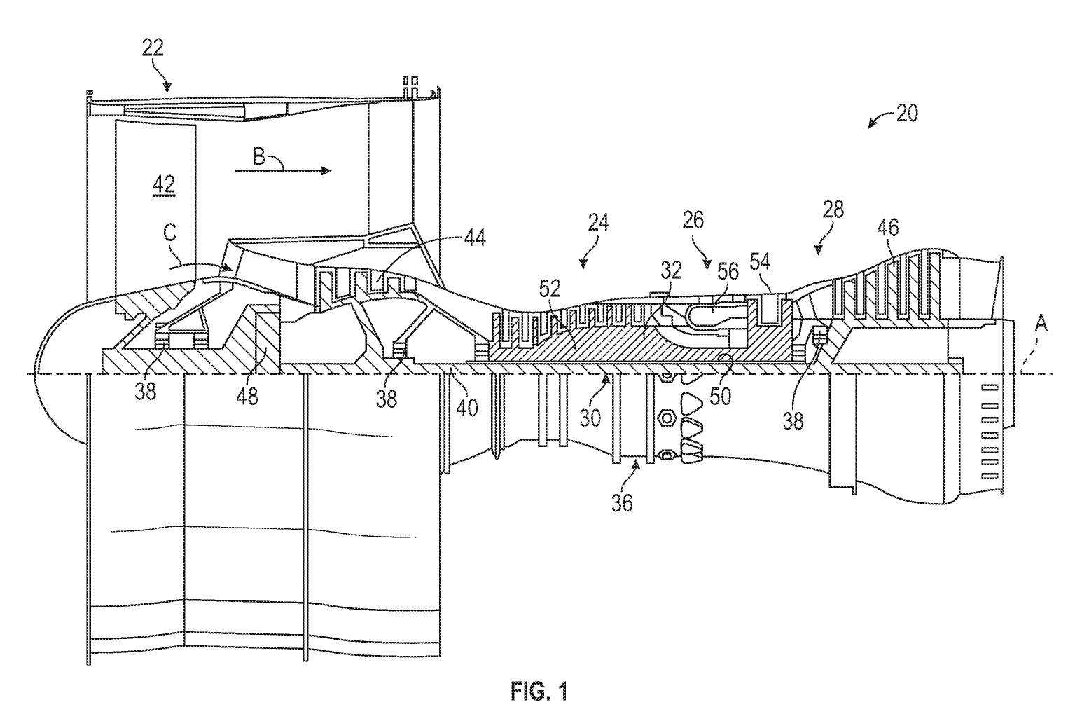

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

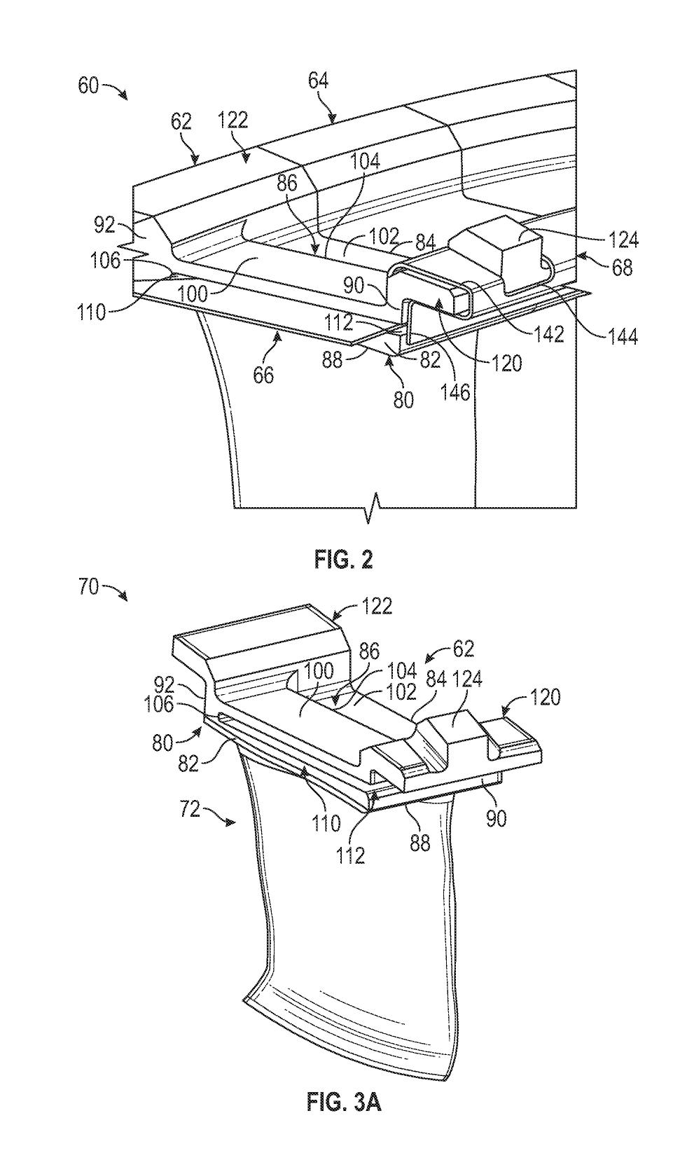

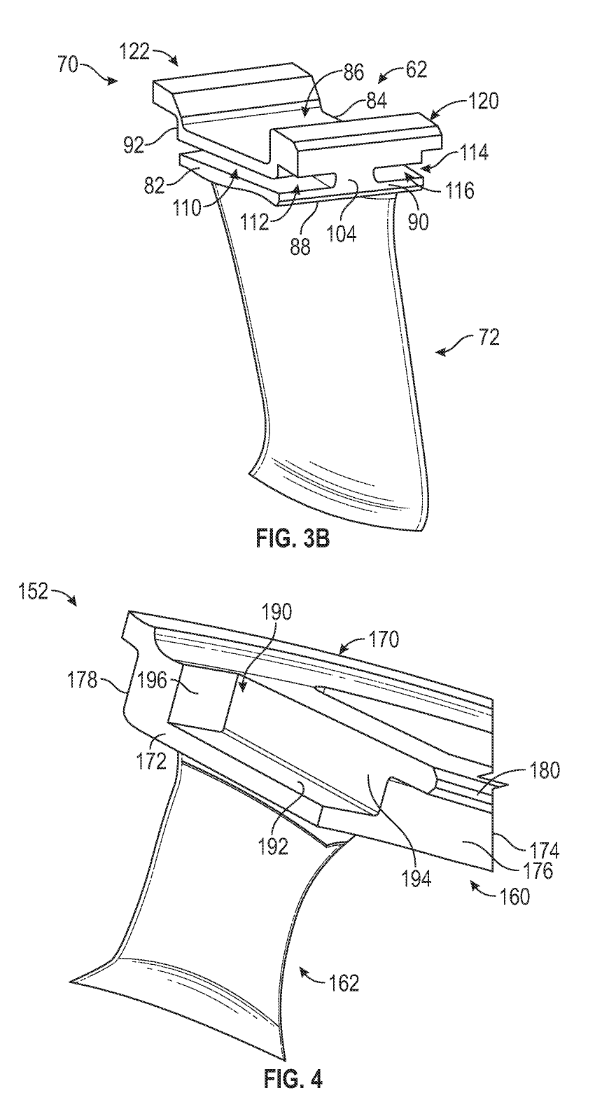

The compressor section 24 of the turbine section 28 may be provided with stator arrays or stator vane assemblies. The stator vane arrays or the stator vane assemblies may be clusters of stator vanes or may be cantilevered singlet stator vanes that mount to vane shroud features at an outer diameter. The stator vane arrays or the stator vane assemblies may be coupled to a common shroud or independent shrouds. Gaps may be present between circumferential ends (relative to the engine central longitudinal axis A) of the shrouds that may lead to air flow leakage from a pressurized gas path that is radially inboard (relative to the engine central longitudinal axis A) of the shrouds to a lower pressure gas path radially outboard (relative to the engine central longitudinal axis A) to the shrouds. Leakage through these gaps may reduce overall gas turbine engine efficiency. Various sealing mechanisms may be employed to reduce possible leakage between the gaps, for example, a first embodiment of a sealing mechanism is shown in FIGS. 2 and 3 or a second embodiment of a sealing mechanism is shown in FIGS. 4-6.

Referring to FIGS. 2 and 3A, a stator vane assembly 60 is shown. The stator vane assembly 60 includes a first stator vane 62, a second stator vane 64, a sealing member 66, and a liner 68.

The first stator vane 62 is disposed adjacent to and is at least partially circumferentially spaced apart from the second stator vane 64 and an adjacent stator vane. The adjacent stator vane is disposed opposite the second stator vane such that the first stator vane 62 is disposed between the second stator vane 64 and the adjacent stator vane. The first stator vane 62 includes a first outer shroud 70 and a first airfoil 72 extending from the first outer shroud 70.

The first outer shroud 70 is affixed or mounted to a vane shroud such that the first stator vane 62 is a cantilevered mounted singlet vane. The first outer shroud 70 is provided with a first body 80 having a first body first side 82, a first body second side 84, a first wall 86, and a second wall 88. The first body second side 84 is disposed opposite the first body first side 82. The first body first side 82 and the first body second side 84 each axially extends between a first body first end 90 and a first body second end 92.

The first wall 86 circumferentially extends between the first body first side 82 and the first body second side 84. The first wall 86 axially extends between the first body first end 90 and the first body second end 92. The first wall 86 may include a first wall first portion 100 and a first wall second portion 102. The first wall first portion 100 is disposed parallel to but not coplanar with the first wall second portion 102 such that the first wall 86 is arranged as a stepped wall. In at least one embodiment, the first wall second portion 102 may be disposed radially closer to the engine central longitudinal axis A than the first wall first portion 100.

The second wall 88 is radially spaced apart from the first wall 86. The second wall 88 circumferentially extends between the first body first side 82 and the first body second side 84. The second wall 88 axially extends between the first body first end 90 and the first body second end 92.

A first step or a first side wall 104 radially extends between and is disposed generally perpendicular to the first wall first portion 100 and the first wall second portion 102. The first side wall 104 axially extends between the first body first end 90 and the first body second end 92. The first side wall 104 is disposed between the first body first side 82 and the first body second side 84.

A first body end wall 106 is disposed proximate or at the first body second end 92. The first body end wall 106 radially extends between and is disposed generally perpendicular to the first wall 86 and the second wall 88. The first body end wall 106 circumferentially extends between the first body first side 82 towards the first body second side 84 and terminates proximate or dead ends at the first side wall 104.

The first wall 86 (e.g. the first wall first portion 100), the second wall 88, the first side wall 104, and first body end wall 106 of the first outer shroud 70 define a first slot 110. The first slot 110 axially extends from the first body first end 90 towards the first body second end 92 and terminates at the first body end wall 106. The first slot 110 circumferentially extends from the first body first side 82 towards the first body second side 84 and terminates before or dead ends at the first side wall 104.

The first body 80 of the first outer shroud 70 defines a first opening 112. The first opening 112 axially extends from the first body first end 90 towards and into the first slot 110. The first opening 112 configures at least a portion first body first end 90 as an open end and the first body end wall 106 configures at least a portion of the first body second end 92 as a closed end or dead end.

Referring to FIG. 3B, the first wall 86, the second wall 88, the first side wall 104, and the first body end wall 106 of the first outer shroud 70 define a second slot 114 that is disposed opposite and extends towards the first slot 110. The first slot 110 is separated from the second slot 114 by the first sidewall 104. The second slot 114 axially extends from the first body first end 90 towards the first body second end 92. The second slot 114 circumferentially extends from the first body second side 84 towards the first body first side 82 and terminates proximate or dead ends at the first side wall 104.

The first body 80 of the first outer shroud 70 defines a second opening 116. The second opening 116 axially extends from the first body first end 90 towards and into the second slot 114. The second opening 116 configures at least a portion first body first end 90 as an open end and the first body end wall 106 configures at least a portion of the first body second end 92 as a closed end or dead end.

The first outer shroud 70 includes a first hook 120 and a second hook 122. The first hook 120 extends from the first wall 86 from the first body first end 90. The first hook 120 is provided with an anti-rotation feature 124 that is configured as a protrusion or protuberance. The second hook 122 is disposed opposite the first hook 120. The second hook 122 extends from the first wall 86 from the first body second end 92.

The sealing member 66 is disposed in or is at least partially received within the first slot 110. The sealing member 66 may also be disposed in or at least partially received within the second slot and a first slot of the adjacent second stator vane 64. The sealing member 66 may be a feather seal. The sealing member 66 includes a first side 130, a second side 132, a first end 134, and the second end 136. The first side 130 and the second side 132 axially extend between the first end 134 and the second end 136. The first side 130 is disposed outside of the first slot 110 and may be received within a slot of an outer shroud of an adjacent stator vane. The second side 132 is disposed within the first slot 110. The first end 134 is disposed proximate the first body first end 90. The second end 136 is disposed proximate the first body second end 92.

The sealing member 66 is provided with a beveled region 138. The beveled region may extend between the second side 132 and the second end 136. The beveled region 138 may be disposed proximate the first body end wall 106 and the first side wall 104.

The sealing member 66 is arranged to move radially or axially within the first slot 110 due to intentional leakage between the first outer shroud 70 of the first stator vane 62 and an adjacent stator vane such that the sealing member 66 may seat against an interior surface of the first wall 86 and the first body end wall 106. The sealing member 66 is arranged to discourage further leakage between the first stator vane 62 and adjacent stator vane by bridging the gap between the first stator vane 62 and the adjacent stator vane.

The liner 68 is disposed about the first hook 120 of the first outer shroud 70. A first portion 142 of the liner 68 defines an opening 144 through which the anti-rotation feature 124 extends. A second portion 146 of the liner 68 extends from the first portion 142. The second portion 146 is disposed parallel to the first body end wall 106 and extends over the first opening 112.

Referring to FIGS. 4-6, a stator vane assembly 150 is shown. The stator vane assembly 150 includes a first stator vane 152 and a second stator vane 154. The first stator vane 152 and the second stator vane 154 are connected to each other and a sealing mechanism may extend between the first stator vane 152 and the second stator vane 154 to seal or provide a more tortuous sealing path to prevent or inhibit leakage between the first stator vane 152 and the second stator vane 154.

Referring to FIG. 4, the first stator vane 152 includes a first outer shroud 160 and a first airfoil 162 that extends from the first outer shroud 160. The first outer shroud 160 is affixed or mounted to a vane shroud such that the first stator vane 152 is a cantilevered mounted singlet vane. The first outer shroud 160 is provided with a first body 170 having a first body first side 172 and a first body second side 174 both axially extending between a first body first end 176 and a first body second end 178. A first lip 180 axially extends from the first body first end 176.

The first body 170 defines a first recess 190 that circumferentially extends from the first body first side 172 along a first floor 192 towards the first body second side 174 and terminates at a first side wall 194. The first recess 190 axially extends from the first body first end 176 along the first floor 192 towards a first body end wall 196 that is disposed proximate or at the first body second end 178.

The first floor 192 circumferentially extends between the first body first side 172 towards the first side wall 194. The first floor 192 axially extends between the first body first end 176 and the first body end wall 196.

The first side wall 194 axially extends between the first body end wall 196 and the first body first end 176. That is one embodiment, the first side wall 194 axially extends into or along the first lip 180.

The first body end wall 196 circumferentially extends between the first body first side 172 and the first side wall 194. The first body end wall 196 is disposed generally perpendicular to the first floor 192 and the first side wall 194.

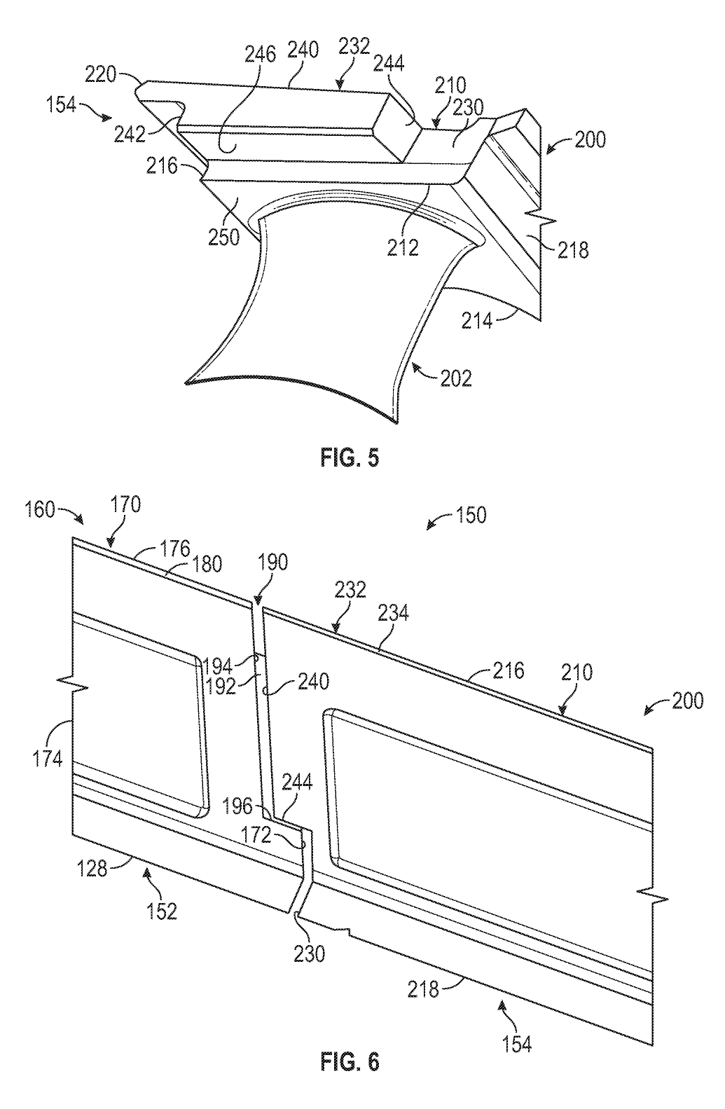

Referring to FIG. 5, the second stator vane 154 includes a second outer shroud 200 and a second airfoil 202 that extends from the second outer shroud 200. The second outer shroud 200 is circumferentially spaced apart from the first outer shroud 160. The second outer shroud 200 is affixed or mounted to a vane shroud such that the second stator vane 154 is a cantilevered mounted singlet vane. The second outer shroud 200 is provided with the second body 210 having a second body first side 212 and a second body second side 214 both axially extending between a second body first end 216 and a second body second end 218.

The second body 210 includes a second side wall 230, a tongue 232, and a second lip 234. The second side wall 230 axially extends between the second body first end 216 and the second body second end 218. In at least one embodiment, the second side wall 230 is arranged to engage at least a portion of the first body first side 172.

The tongue 232 is arranged to be at least partially received within the first recess 190. The tongue 232 circumferentially extends from the second side wall 230 towards the first outer shroud 160. The tongue 232 circumferentially extends between the second side wall 230 and a tongue end wall 240 that is arranged to be disposed proximate the first side wall 194. The first side wall 194 is disposed in a nonparallel and non-perpendicular relationship with respect to the tongue end wall 240. The tongue end wall 240 is arranged to abut or be disposed proximate the first side wall 194, as shown in FIG. 6.

The tongue 232 includes the tongue end wall 240, a first tongue end 242, a second tongue end 244, and a tongue floor 246. The first tongue end 242 is disposed parallel to and generally coplanar with the second body first end 216. The first tongue end 242 is arranged to be disposed generally parallel to the first body first end 176. The second tongue end 244 is disposed generally parallel to and is axially offset from the second body second end 218. The second tongue end 244 extends between and is disposed generally perpendicular to the second side wall 230, the tongue end wall 240, and the tongue floor 246. The second tongue end 244 is arranged to abut or be disposed proximate the first body end wall 196, as shown in FIG. 6.

The tongue floor 246 extends between and is disposed generally perpendicular to the second side wall 230 and the tongue end wall 240. The tongue floor 246 is radially spaced apart from an underside 250 of the first outer shroud 160. The tongue floor 246 is arranged to abut or be disposed proximate the first floor 192.

The second lip 234 axially extends from the second body first end 216 and/or the first tongue end 242. The second lip 234 is arranged to abut the first lip 180.

The receiving of the tongue 232 within the first recess 190 creates a flow restrictor device that minimizes or discourages leakage through a potential gap between the first outer shroud 160 and the second outer shroud 200.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stator vane assembly, comprising:
a first stator vane, comprising:
a first outer shroud mounted to a vane shroud such that the first stator vane is a cantilevered mounted singlet vane, the first outer shroud provided with a first body having a first body first side and a first body second side axially extending between a first body first end and a first body second end, the first outer shroud defining a first slot axially extends from the first body first end towards a first body end wall disposed at the second end; and
a first airfoil radially extending from the first outer shroud.

2. The stator vane assembly of claim 1, wherein the first body first end defines a first opening axially extends into the first slot.

3. The stator vane assembly of claim 1, wherein the first slot circumferentially extends from the first body first side towards a first side wall that is disposed between the first body first side and the first body second side.

4. The stator vane assembly of claim 1, further comprising:
a sealing member disposed at least partially in the first slot.

5. The stator vane assembly of claim 4, wherein the sealing member is provided with a beveled region that is disposed proximate the first body end wall.

6. A stator vane assembly, comprising:
a first stator vane, comprising:
a first outer shroud mounted to a vane shroud, the first outer shroud provided with a first body having a first body first side and a first body second side axially extending between a first body first end and a first body second end, the first body defining a first recess that circumferentially extends from the first body first side, along a first floor, towards a first side wall and axially extends from the first end, along the first floor, towards a first body end wall disposed proximate the first body second end; and
a second stator vane, comprising:
a second outer shroud mounted to the vane shroud, the second outer shroud provided with a second body having a second side wall axially extending between a second body first end and a second body second end, the second body having a tongue that circumferentially extends from the second side wall, the tongue arranged to be at least partially received within the first recess.

7. The stator vane assembly of claim 6, wherein a first lip axially extends from the first body first end.

8. The stator vane assembly of claim 7, wherein a second lip axially extends from the second body first end and is arranged to abut the first lip.

9. The stator vane assembly of claim 8, wherein the tongue axially extends between a first tongue end that is disposed parallel to and generally coplanar with the second body first end and a second tongue end that is arranged to abut the first body end wall.

10. The stator vane assembly of claim 9, wherein the second tongue end is disposed parallel to and is axially offset from the second body second end.

11. The stator vane assembly of claim 8, wherein the tongue circumferentially extends between the second side wall and a tongue end wall that is arranged to be disposed proximate the first side wall.

12. The stator vane assembly of claim 11, wherein the first side wall is disposed in a nonparallel and non-perpendicular relationship with the tongue end wall.

13. A gas turbine engine, comprising:
a first stator vane, comprising:
a first outer shroud mounted to a vane shroud such that the first stator vane is a cantilevered mounted singlet vane, the first stator vane having a first body provided with a first wall spaced apart from a second wall axially extends between a first body first end and a first body second end, the first wall axially extends between a first body first side and a first body second side, a first body end wall radially extends between the first wall and the second wall and is disposed proximate the first body second end, and a first side wall radially extends between the first wall and the second wall and axially extends between the first body end wall and the first body first end, the first wall, the second wall, the first body end wall, and the first side wall defining a first slot.

14. The gas turbine engine of claim 13, wherein the second wall is radially spaced apart from the first wall.

15. The gas turbine engine of claim 13, further comprising:
a sealing member at least partially received within the first slot.

16. The gas turbine engine of claim 13, wherein the first outer shroud has a first hook that extends from the first body first end and a second hook that extends from the first body second end.

17. The gas turbine engine of claim 16, wherein the first body defines a first opening axially extends from the first body first end into the first slot.

18. The gas turbine engine of claim 17, further comprising:
a liner disposed about the first hook and having a portion that extends over the first opening.

19. The gas turbine engine of claim 18, wherein the portion of the liner is disposed parallel to the first body end wall.
